(19) United States
(12) Patent Application Publication
(10) Pub. No.: US 2003/0152703 A1
(43) Pub. Date: Aug. 14, 2003

(54) Production of chemically patterned surfaces using polymer-on-polymer stamping

(76) Inventors: Paula T. Hammond, Newton, MA (US); Xueping Jiang, Wilmington, DE (US); Haipeng Zheng, Cambridge, MA (US); Shoshana Gourdin, Cambridge, MA (US)

Correspondence Address: Dana M. Gordon, Ph.D., J.D., Foley Hoag LLP, 155 Seaport Boulevard, Boston, MA, 02210, US

(21) Appl. No.: 10/285,337

(22) Filed: Oct. 31, 2002

Related U.S. Application Data
(60) Provisional application No. 60/335,020, filed on Oct. 31, 2001.

(51) Int. Cl. B05D 5/00

(52) U.S. Cl. 427/256

(57) ABSTRACT

One aspect of the present invention relates to a method of creating patterned composite structures on a surface via layer-by-layer deposition of thin films. In certain embodiments, the surface is chemically patterned by the direct stamping of functional polymers on the surface film. A pattern may then be used as a template for the further depositions of materials on the surface. This concept may be applied to various functional polymer and substrate systems as well as various thin film deposition techniques.

### RELATED APPLICATIONS

This application claims the benefit of priority to U.S. Provisional Patent Application serial No. 60/335,020, filed Oct. 31, 2001.

### GOVERNMENT SUPPORT

This invention was made with support provided by the Office of Naval Research (Grant No. N00014-96-1-0789) and the MRSEC program of the National Science Foundation (Grant No. DMR-9400334); therefore, the government has certain rights in the invention.

### BACKGROUND OF THE INVENTION

Organic thin films continue to attract great interest in the materials science community due to their ease of processing, ease of functionalization, light weight and flexibility. Significant progress has been achieved in the past 10-20 years, presenting the possibility of molecular level control in molecular and macromolecular composite films. The ionic, layer-by-layer assembly technique, introduced by Decher in 1991, is among the most exciting recent developments in this area. Decher, G.; Hong, J.-D. Makromol. Chem., Macromol. Symp. 1991, 46, 321-327; Decher, G.; Hong, J.-D. Ber. Bunsenges. Phys. Chem. 1991, 95, 1430-1434; and Decher, G.; Hong, J. D.; Schmitt, J. Thin Solid Films 1992, 210/211, 831. This approach, which utilizes electrostatic interactions between oppositely charged polyion species to create alternating layers of sequentially adsorbed polyions, provides a simple and elegant means of depositing layer-by-layer sub-nanometer-thick polymer films onto a surface using aqueous solutions. Lvov, Y. M.; Decher, G. Crystallography Reports 1994, 39, 628-647; Ferreira, M.; Rubner, M. F. Macromol. 1995, 28, 7107-7114; and Tsukruk, V. V.; Rinderspacher, F.; Bliznyuk, V. N. Langmuir 1997, 13, 2171-2176. More recently, applications have been extended to electroluminescent LEDs, conducting polymer composites as well as the assembly of proteins and metal nanoparticle systems. Tian, J.; Wu, C. C.; Thompson, M. E.; Sturm, J. C.; Register, R. A.; Marsella, M. J.; Swager, T. M. Adv. Mater. 1995, 7, 395; Baur, J. W.; Kim, S.; Balanda, P. B.; Reynolds, J. R.; Rubner, M. F. Advanced Materials 1998, 10, 1452-1455; Cheung, J. H.; Fou, A. F.; Rubner, M. F. Thin Solid Films 1994, 244, 985-989; Ferreira, M.; Cheung, J. H.; Rubner, M. F. Thin Solid Films 1994, 244, 806-809; Lvov, Y.; Ariga, K.; Ichinose, I.; Kunitake, T. J. Am. Chem. Soc. 1995, 117, 6117-6123; and Ariga, K.; Lvov, Y.; Onda, M.; Ichinose, I.; Kunitake, T. Chemistry Letters 1997, 125-126.

Application of organic thin films to integrated optics, microelectronic devices, sensors and optical memory devices requires a means of patterning and controlling the surface architecture. Photolithography is the conventional patterning technique of choice, but lithographic techniques require materials designed to exhibit efficient responses to irradiation with a chemical change, namely crosslinking or degradation; these requirements are not trivial. Finally, light-based lithography can be limited in its application to curved, nonplanar surfaces, such as optical lenses and fibers, and multiple processing steps are required to create three dimensional, multiple level microstructures.

Patterning polymeric thin films in situ through the use of chemically patterned surfaces as templates for ionic multilayer assembly has been presented. Hammond, P. T.; Whitesides, G. M. Macromolecules 1995, 28, 7569; Clark, S. L.; Montague, M.; Hammond, P. T. Supramol. Sci. 1997, 4, 141-146; Clark, S. L.; Montague, M. F.; Hammond, P. T. Macromol. 1997, 30, 7237-7244; Clark, S. L.; Hammond, P. T. Adv. Mat. 1998, 10, 1515-1519; Clark, S. L.; Handy, E. S.; Rubner, M. F.; Hammond, P. T. ACS Polym. Prepr. 1998, 39, 1079-1080; Clark, S. L.; Montague, M. F.; Hammond, P. T. ACS Symp. Ser. 1998, 695, 206-219; and Clark, S. L.; Handy, E. S.; Rubner, M. F.; Hammond, P. T. Advanced Materials 1999, 11, 1031-1035. Selective deposition was achieved by introducing alternating regions of two different chemical functionalities on a surface: one which promotes adsorption; and a second which effectively resists adsorption of polyions on the surface. More recent explorations have illustrated that by adjusting the ionic strength, pH and polyion chemical structure, one can tune the interactions between polyions and the surface functional groups, allowing different polyion pairs to be adsorbed on specific regions of the surface based on electrostatic, hydrogen bonding, and hydrophobic interactions.

Alkane thiols and silanes have been used to create functionalized self-assembled monolayers (SAMs) on gold and silicon substrates, respectively, using the micro-contact printing method. Kumar, A.; Biebuyck, H. A.; Whitesides, G. M. Langmuir 1994, 10, 1498-1511; Xia, Y.; Whitesides, G. M. J. Am. Chem. Soc. 1995, 117, 3274-3275; Xia, Y.; Mrksich, M.; Kim, E.; Whitesides, G. M. J. Am. Chem. Soc. 1995, 117, 9576-9577; and Kumar, A.; Whitesides, G. M. Science 1994, 263, 60-62. More recently, other molecular systems such as polymers and ligands have been stamped onto surfaces; in these cases, the molecules were stamped onto a reactive alkanethiolate SAM. Goetting, L. B.; Deng, T.; Whitesides, G. M. Langmuir 1999, 15, 1182-1191; and Lahiri, J.; Ostuni, E.; Whitsides, G. M. Langmuir 1999, 15, 2055-2060. A novel and desirable advancement in this art would be the use of functionalized polymers, polyions and low molar mass substituents which can be stamped directly onto other surfaces, particularly plastic substrates and multilayer films, by careful selection of surface chemistry. The motivation for establishing these routes are two-fold: 1) the functionalization and subsequent patterning of ionic multilayers and other materials on a broad range of substrates, including polymeric surfaces, without elaborate pretreatment; and 2) the creation of complex multiple level heterostructures via stamping atop continuous or patterned polymer thin films, followed by subsequent selective adsorption or deposition steps. The ability to create multi-level microstructures with layer-by-layer assembly broadens the area by allowing the construction of devices such as transistors, diodes, sensors, and other optical and electrical components. The chemical patterning of the top surfaces of multilayer films also brings new opportunities to incorporate other materials onto multilayer films; the use of such chemical patterns to direct materials deposition can lead to the patterning of metal electrodes, the placement of colloidal particles, or the directed deposition of other polymer films atop layer-by-layer functional thin films. Importantly, the ability to create patterned functional chemistry atop a polyelectrolyte surface would enable modification of any surface which can be covered with at least one surface layer of polyion.

Therefore, the need exists to be able to create a desired chemically patterned surface by stamping copolymers which contain two different types of functional groups—one functional group which can attach to the polymer surface, and a second functional group which acts as the desired surface modifier—onto polyelectrolyte multilayer surfaces. Such multifunctional molecules include block and random copolymers, graft copolymers, and polyelectrolytes, as well as some surfactants. The process would be advantageous over current SAM methods, e.g., alkanethiols upon gold surfaces, because the resulting films would be more flexible, more thermally stable, and less expensive.

### SUMMARY OF THE INVENTION

The invention enables production of polymer thin films with well-defined bonding environments and surface properties. Accordingly, in one aspect, the invention provides a method for patterning surfaces using a copolymer stamping process. In one aspect of the invention, the copolymer is covalently attached to the surface. In another aspect of the invention, the copolymer is a block or graft copolymer and is attached electrostatically to the surface. In a further aspect of the invention, the electrostactically attached copolymer is a polyelectrolyte. In another aspect, the invention provides for an article coated according to a method of the present invention.

### BRIEF DESCRIPTION OF THE DRAWING

FIG. 1 depicts schematic diagrams of: (a) microcontact printing on a polyelectrolyte multilayer platform; and (b) a polyelectrolyte layer-by-layer adsorption process which provides patterned multilayers.

FIG. 2 depicts the chemical structure of a copolymer consisting of oligoethylene glycol allyl ether and maleic anhydride (EO-MAL).

FIG. 3 depicts the grazing angle FTIR (GA-FTIR) spectra (800-3500 cm⁻¹) of (a) BPEI adsorbed on an COOH SAM at pH 8.6; (b) the same BPEI surface immersed in EO-MAL methanol solution for 20 mins; (c) a similar BPEI surface immersed in EO-MAL methanol solution overnight (12 hrs); and (d) a HS(CH₂)₁₁(OCH₂CH₂)₃OH SAM (EG SAM) on an Au substrate.

FIG. 4 depicts AFM images of patterned 10 bilayers of LPEI/PAA via EO-MAL stamping on amino silane SAMs pretreated at various pHs: a) pH 5; b) pH 7; c) pH 10; d) patterned 10 bilayers of (PDAC/SPS) formed by stamping EO-MAL on amino silane SAMs pretreated at pH 10.

FIG. 5 depicts AFM images of patterned multilayers on various substrates: a) COOH SAM/Au substrate: (SPS/PDAC)16 on (BPEI/PAA)5BPEI platform layered at pH 5; b) Si substrate: (SPS/PDAC)10 on (BPEI/PAA)5BPEI platform layered at pH 4.5 for PAA and pH 7.0 for BPEI; and c) PS slide: (SPS/PDAC)15 on (BPEI/PAA)5BPEI platform layered at pH 5.

FIG. 6 depicts complex microstructures formed by stamping EO-MAL on patterned surfaces: a) a multiple level patterning scheme in which vertical stripes on the substrate are patterned polyion multilayers with polyamine as the outermost layer, and horizontal lines on the stamp represent EO-MAL ink which will be stamped atop the vertical stripes; b) a model of a complex structure formed by multiple stamping in which the shaded surfaces on the top of the first set of stripes indicate that the original amine surface has been modified with an ethylene glycol surface by stamping EO-MAL, causing the second set of multilayers to deposit only on unmodified amine surface forming cubes; c) an optical micrograph of a complex structure formed by 4 (LPEI/PAA) multilayers and 12 (LPEI/Ru dye) multilayers atop 12 (PDAC/SPS) multilayer stripes; and d) an AFM image of the same sample in which the raised cubes on the stripes correspond to 4 (LPEI/PAA) multilayers and 12 (LPEI/Ru dye) multilayers, and the stripes correspond to 12 (PDAC/SPS) multilayers.

FIG. 7 depicts a schematic drawing of the direct transfer of polymers using polymer-on-polymer stamping, wherein the polymer being transferred may include block and graft copolymers and the surface functional groups include negative or positive charges.

FIG. 8 depicts GA-FTIR spectra of PS-b-PAA films stamped on PAH at three temperatures.

FIG. 9 depicts advancing contact angle data of PS-b-PAA block copolymer films which were contact printed at various temperatures and tested under various solvent conditions.

FIG. 10 depicts advancing contact angle data for PS-PAA block copolymers printed on platforms that were subjected to pretreatment at various pHs.

FIG. 11 depicts a) a condensation figure formed from stamping a PS-PAA block copolymer at room temperature onto an aminosilane SAM without pretreatment; and b) a condensation figure formed from stamping a PS-PAA block copolymer on an SPS/PDAC platform on glass slides followed with a top PAH layer adsorbed at pH 8.5.

FIG. 12 depicts contact angle measurements of water on a blank PDMS surface as a function of its exposure time to air plasma.

FIG. 13 depicts images of PDAC stamping using various solvent solutions and at various stamping times.

FIG. 14 depicts images of PDAC stamping under optimal conditions.

FIG. 15 depicts a) AFM images of PDAC stamping before rinsing, and b) after rinsing.

FIG. 16 depicts patterned PDEOT formed via selective deposition; the lighter regions are the conducting polymer film. Contrasts in the optical microscope image are due to differences in thickness. The thinner stripes are approximately 5 microns in width.

FIG. 17 depicts electroless metal deposition on a polymer template formed by stamping EO-MAL graft copolymer atop the surface of a PAA/PAH polyelectrolyte multilayer. The dark regions are Ni metal. The smallest dimensions are 2-3 microns wide.

### DETAILED DESCRIPTION OF THE INVENTION

Definitions

For convenience, certain terms employed in the specification, examples, and appended claims are collected here.

The term “copolymer” as used herein means a polymer of two or more different monomers.

The term “electrolyte” as used herein means any chemical compound that ionizes when dissolved.

The term “polyelectrolyte” as used herein means a polymeric electrolyte, such as polyacrylic acid.

The term “pH” as used herein means a measure of the acidity or alkalinity of a solution, equal to 7, for neutral solutions and increasing to 14 with increasing alkalinity and decreasing to 0 with increasing acidity.

The term “pH dependent” as used herein means a weak electrolyte or polyelectrolyte, such as polyacrylic acid, in which the charge density can be adjusted by adjusting the pH.

The term “pH independent” as used herein means a strong electrolyte or polyelectrolyte, such as polystyrene sulfonate, in which the ionization is complete or very nearly complete and does not change appreciably with pH.

The term “Ka” as used herein means the equilibrium constant describing the ionization of a weak acid.

The term “pKₐ” as used herein means a shorthand designation for an ionization constant and is defined as pKₐ=−log Kₐ. pKₐ values are useful when comparing the relative strength of acids.

The term “multilayer” as used herein means a structure comprised of two or more layers.

The abbreviation “PAA” as used herein means polyacrylic acid.

The abbreviation “PAH” as used herein means polyallylamine hydrochloride.

The abbreviation “PAAm” as used herein means polyacrylamide.

The abbreviation “PDMS” as used herein means poly(dimethylsiloxane).

The abbreviation “PMA” as used herein means polymethacrylic acid.

The abbreviation “PSS” or “SPS” as used herein are used interchangeably and mean sulfonated polystyrene.

The abbreviation “LPEI” as used herein means linear polyethyleneimine.

The abbreviation “BPEI” as used herein means branched polyethyleneimine.

The abbreviation “PDAC” as used herein means polydiallyldimethyl ammonium chloride.

The abbreviation “PS-b-PAA” as used herein means polystyrene-polyacrylic acid block copolymer.

The abbreviation “PS-b-PMA” as used herein means polystyrene-polymethacrylic acid block copolymer.

The term “stamp” as used herein means a tool or implement used to apply a composition, e.g., a solution comprising a polymer, to a surface.

The term “pattern” as used herein means an intentional arrangement of elements on a surface in such a way that the elements do not cover the entire surface. A pattern may be geometric or repetitive or both.

For purposes of this invention, the chemical elements are identified in accordance with the Periodic Table of the Elements, CAS version, Handbook of Chemistry and Physics, 67th Ed., 1986-87, inside cover.

Stamping Copolymers on a Surface to Serve as Templates for Additional Layers

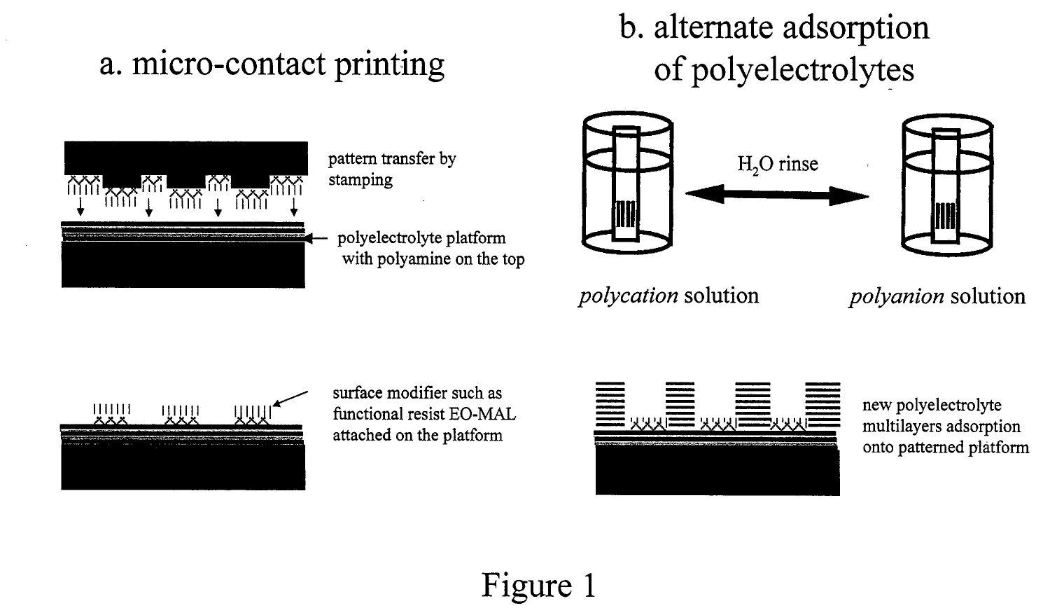

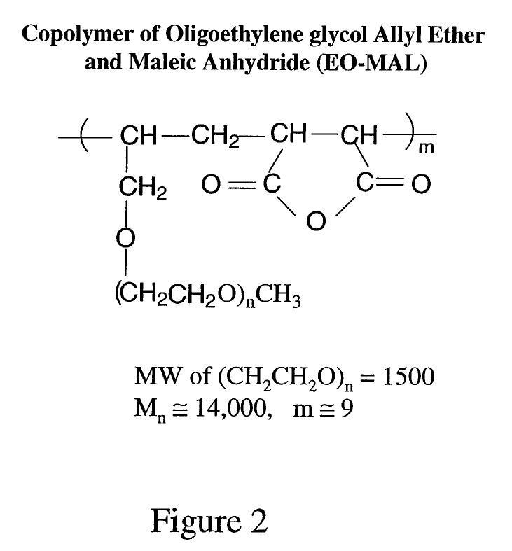

To create surfaces which can act as templates for layer-by-layer adsorption, it is necessary to form surface regions which resist polyion adsorption (see FIG. 1). Particularly, polyethylene oxide (PEO) (also called polyethylene glycol, PEG) and its oligomeric derivatives have thus far been the most effective resist to prevent non-specific adsorption from aqueous solution of polyelectrolytes to surfaces, much as it is effective in preventing protein adsorption on biosurfaces. Clark, S. L.; Montague, M.; Hammond, P. T. Supramol. Sci. 1997, 4, 141-146; Clark, S. L.; Montague, M. F.; Hammond, P. T. Macromol. 1997, 30, 7237-7244; and Prime, K. L.; Whitesides, G. M. J. Am. Chem. Soc. 1993, 115, 10714-10721. Based on this knowledge, a random graft copolymer of oligoethylene oxide allyl ether and maleic anhydride (EO-MAL, shown in FIG. 2) is used as such a multifunctional polymer. It is demonstrated herein that EO-MAL can be used to direct selective adsorption on various substrates, including plastic surfaces, and to create three dimensional complex microstructures of multilayered polymer films. The factors which influence the effectiveness of EO-MAL templates are also addressed.

The polyelectrolytes of the present invention can be categorized into two groups: strong polyelectrolytes, for which the degree of ionization is independent of the solution pH; and weak polyelectrolytes, for which the degree of ionization is determined by the solution pH. Poly(acrylic acid) sodium salt (PAA), linear polyethyleneimine (LPEI) and branched polyethyleneimine (BPEI) are weak polyelectrolytes. Sodium poly(styrene sulfonate) (SPS) and polydiallydimethyl ammonium chloride (PDAC) are strong polyelectrolytes. The best selectivity of patterned thin films can be achieved at 0.1 M NaCl for strong polyelectrolyte (PDAC/SPS) multilayers, and at pH 4.8 for weak polyelectrolyte (LPEI/PAA) multilayers. Clark, S. L.; Montague, M. F.; Hammond, P. T. Macromol. 1997, 30, 7237-7244; and Clark, S. L.; Handy, E. S.; Rubner, M. F.; Hammond, P. T. Advanced Materials 1999, 11, 1031-1035. These optimal conditions were used in the preparation of patterned multilayers. Three different substrates were used: silicon wafers (SiO₂/Si); gold substrates (Au); and hydrophilic polystyrene (PS) cell culture slides. Platform films of five and one half bilayers of (BPEI/PAA) were built up on an HS(CH₂)₁₅COOH SAM (COOH SAM) on gold substrates, on Si substrates and on hydrophilic PS substrates, respectively. The outermost layer in all cases was the polyamine surface, which can react with anhydride groups in EO-MAL. These platforms served as continuous surfaces for the stamping of EO-MAL. Patterned film platforms were also prepared to demonstrate the creation of a second pattern atop an original set of patterned layer-by-layer thin films.

Initial studies were completed on the functionalization of a polyamine surface with the EO-MAL graft copolymer, utilizing FTIR as a means of determining the nature of the adsorbed copolymer on the surface. This work was followed by a study of the stamping of EO-MAL on model amino surfaces, and the effect of pH treatment on the ability of the EO-MAL to resist polyion adsorption from aqueous solution. Studies were performed on multilayer thin film surfaces, and the patterning of a periodic array of multilayer thin film stripes to create multiple level patterns was demonstrated.

1. Preparatiom of the EO-MAL Surface and its Characterization Using Grazing Angle FTIR

As shown in FIG. 2, EO-MAL is a comb-like functional copolymer. The anhydride groups of this copolymer can react the amino groups on a surface to form amide bonds. When EO-MAL is effectively applied to amine surfaces, PEO brushes are expected to cover the substrate and resist polyelectrolyte adsorption from aqueous solution.

To determine if EO-MAL can be effectively reacted with amine surfaces to obtain a resist surface, we used a single layer of BPEI adsorbed on a COOH SAM/Au substrate as an amine surface, and immersed the BPEI surface into an EO-MAL methanol solution for different time periods. Contact angle measurements and ellipsometry indicated the adsorption of EO-MAL on the surface in all cases. Grazing angle FTIR (GA-FTIR) spectra were collected to examine the nature of the resulting EO-MAL layer adsorbed on the amine surface. The spectra were taken with 1024 scans at a resolution of 2 cm⁻¹ and a ratio was taken against the spectrum of an n-C₁₆D₃₃SH SAM.

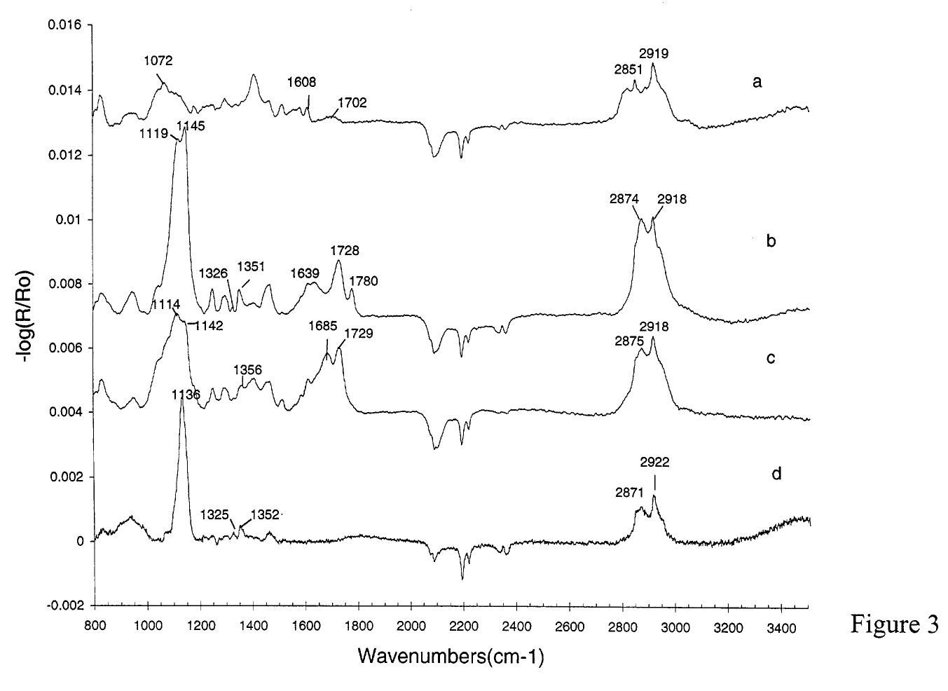

FIG. 3 presents the GA-FTIR spectra (800-3500 cm⁻¹) of (a) BPEI adsorbed on an COOH SAM at pH 8.6; (b) same BPEI surface immersed in EO-MAL methanol solution for 20 mins; (c) a similar BPEI surface immersed in EO-MAL methanol solution overnight (12hrs); and (d) a HS(CH₂)₁₁(OCH₂CH₂)₃OH SAM (EG SAM) on a Au substrate. Negative absorption bands in the 2050-2200 cm⁻¹ range are due to the C-D absorption for the perdeuterated reference sample. Table 1 lists the key absorption bands of these samples. The 2919 cm⁻¹ and 2851 cm⁻¹ peaks in FIG. 3a correspond to the asymmetric and symmetric C-H stretching modes in the CH₂ repeat unit of BPEI, respectively. The 1702 cm⁻¹ broad peak is caused by the COOH SAM underlying the BPEI layer. A 2871-2874 cm⁻¹ peak appears in FIGS. 3b-d, and represents the symmetric OCH₂ stretch mode characteristic for gauche conformations in the oligoethyelene glycol side chain. Also associated with the ether linkage are peaks at 1145 cm⁻¹ and 1119 cm⁻¹ in FIG. 3b, and 1114 cm⁻¹ peak in FIG. 3c that indicate the C—O—C stretching mode of the oligoethylene glycol chain. Such band assignments can be compared to those for the EG SAM spectrum in FIG. 3d, where C—O—C is of 1136 cm⁻¹. The differences in the location of the C—O—C peaks are caused by different PEG chain conformations. Harder, P.; Grunze, M.; Dahint, R.; Whitesides, G. M.; Laibinis, P. E. J. Phys. Chem. B 1998, 102, 426-436. An EG SAM on gold usually exhibits a strong peak at 1130 cm⁻¹ with an 1145 cm⁻¹ shoulder. For poly(ethylene glycol) in the bulk state, the hydrated crystalline phase has a preferential helical conformation consisting of a trans conformation around the C—O bonds and a gauche conformation around the C—C bonds(TGT). Takahashi, Y.; Tadokoro, H. Macromolecules 1973, 6, 672. This PEG crystalline form usually exhibits a strong absorption of the C—O—C stretch mode at 1149 cm⁻¹ and 1119 cm⁻¹. Harder, P.; Grunze, M.; Dahint, R.; Whitesides, G. M.; Laibinis, P. E. J. Phys. Chem. B 1998, 102, 426-436. In the amorphous phase, the predominant conformation of the C—C bond is still gauche, but the C—O bond exists in both trans and gauche configurations (TGT, TGG, GGT). Matsuura, H.; Miyazawa, T. J. Polym. Sci. Part A-2 1969, 7, 1735-1744. The C—O—C stretch mode of amorphous PEG is usually located at 1107 cm⁻¹ (strong peak) with a shoulder at 1140 cm⁻¹. Harder, P.; Grunze, M.; Dahint, R.; Whitesides, G. M.; Laibinis, P. E. J. Phys. Chem. B 1998, 102, 426-436. FIG. 3b-c indicates a transition of the PEG graft chains from a predominantly helical conformation to an amorphous conformation. The C—C bonds maintain the gauche conformation, similar to that observed in the amorphous state of the bulk homopolymer PEG, as indicated by the gauche CH₂—CH₂ wagging band at 1351 cm⁻¹ in FIG. 3b and 1356 cm⁻¹ in FIG. 3c. In reference [29], the 1350 cm⁻¹peak is assigned to the gauche CH₂—CH₂ wagging band, while 1325 cm⁻¹ is assigned to the C—C trans conformation in the oligoethylene glycol moiety, which is rather weak in both FIGS. 3b and 3c.

Recent research results from Harder et al. show that the molecular conformation in oligo(ethylene glycol) (EG)-terminated SAMs determines their ability to resist protein adsorption. Harder, P.; Grunze, M.; Dahint, R.; Whitesides, G. M.; Laibinis, P. E. J. Phys. Chem. B 1998, 102, 426-436. The predominantly crystalline helical and the amorphous forms of EG on the gold substrate resist protein adsorption, while the densely packed “all-trans” form of EG on silver surfaces adsorbs protein. The most probable reason for these differences is that the helical and amorphous forms can bind interfacial water molecules effectively and act as a resist via steric repulsion due to a strong degree of hydration. Wang, R. L. C.; Kreutzer, H. J.; Grunze, M. J. Phys. Chem. B. 1997, 101, 9767-9773. On the contrary, the all-trans conformation is a dense crystalline form that does not allow room for the EG moiety to adsorb water molecules; in this case, nonspecific protein adsorption can be induced via hydrophobic interactions or hydrogen bonding with the EG segments. For the grafted PEG chains in this random copolymer, there is no evidence of formation of the all trans crystalline conformation. The FTIR results above indicate that the PEG grafts actually maintain the amorphous or helical forms; therefore, PEG grafts should work well as a resist layer.

A key difference between FIGS. 3b and 3c is found in the carbonyl stretching region. Peaks at 1780 cm⁻¹ and 1728 cm⁻¹ in FIG. 3b are asymmetric and symmetric C═O stretching modes of hydrolyzed anhydride groups in EO-MAL, showing only physical adsorption of EO-MAL on the amine surface. In FIG. 3c, a new peak at 1685 cm⁻¹ emerges, which is the amide I band; and only a 1729 cm⁻¹ peak is left for C═O at higher wavenumbers corresponding to carboxylic acid groups. These spectra indicate that the anhydride groups have reacted with amino groups on the surface, forming amide bonds (1685 cm⁻¹), and producing carboxylic acid groups (1729 cm⁻¹). These findings suggest that chemisorption of EO-MAL to the amine surface through the formation of amide bonds is kinetically slow, and takes place over long time frames (hours) at room temperature, whereas short time immersion (minutes) results in physisorption. For long term stability toward various pH conditions in aqueous environments, chemisorption is desired.

As indicated by the FTIR results, residual carboxylic acid groups are left on the surface as the product of the reaction of surface amine groups with anhydride groups. The presence of these secondary groups can actually promote adsorption of polyions from solution based on electrostatics or secondary interactions; this matter presents a challenge in the creation of an effective resist layer. Ideally, a brush structure should form when EO-MAL adsorbs on the surface, whether adsorption occurs physically or chemically. The long PEG grafted chains of the EO-MAL copolymer could then provide sufficient surface coverage to prevent interaction of adsorbing polyion chains with residual COOH groups buried underneath. On the other hand, the sequential layering process involves multiple cycles in aqueous and rinse solutions, which may ultimately cause surface reconstruction. Partially ionized COOH groups may ultimately become exposed to the surface and induce adsorption of polyions. To avoid these problems, a very dense and reactive amino layer is desired to get complete conversion of anhydride groups to amide bonds. In the following section, the general use of this approach for patterning is investigated, and the controlled conversion of anhydride groups to maximize the resist quality of the adsorbed EO-MAL film is addressed.

2. Patterning EO-MAL on an Amino Silane Model Surface: Effect of PH

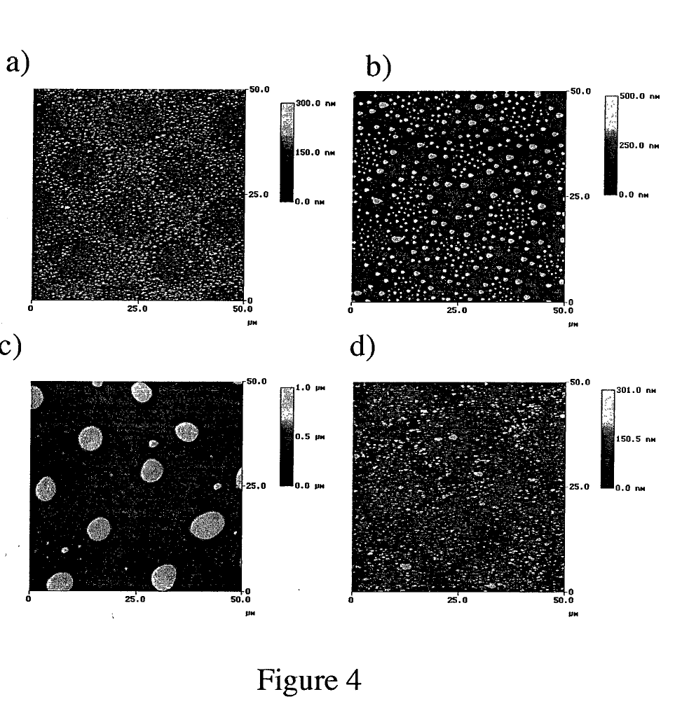

Neutral amine groups are highly reactive toward anhydride groups, whereas protonated ammonium salts are not. For this reason, pH adjustment was used to control the reactivity of amine groups, and thus increase the conversion of anhydride groups to form amide linkages to the surface, and decrease the number of free acid groups. A propylaminosilane SAM on a SiO₂/Si substrate was used as a model amine surface to investigate how pH conditions affect the attachment of EO-MAL and its ability to resist polyion adsorption. Propylaminosilane SAMs were formed on SiO₂/Si substrates by immersing cleaned Si substrates into 2 mM of aminopropyl trimethoxysilane ethanol solution for 2 hrs. These amine surfaces were then immersed into pH adjusted water at pH 5, pH 7 and pH 10 for 20 mins, respectively. The substrates were patterned by directly stamping EO-MAL on the surface for 0.5 hr with an oxygen plasma treated PDMS stamp. Following stamping, 10 bilayers of (PAA/LPEI) were deposited on the EO-MAL patterned surface at pH 4.8. The pattern chosen consists of 10 μm diameter dots; the stamped region is the continuous matrix surrounding the dots. The EO-MAL acts as a resist surface, and the amino groups in the unstamped regions are highly charged at pH 4.8 and hence should promote adsorption. Positive deposition refers to the deposition of polyion multilayers primarily on the untreated amino regions of the surface, resulting in a positive image of raised dots. Negative deposition is given by enhanced adsorption on the EO-MAL resist region, resulting in a negative image of film deposited on the surrounding matrix area of the pattern. AFM images for samples pretreated at the three different pH conditions (FIGS. 4a-c) show a transition from negative to positive deposition. In all cases, adsorption of polyions may occur on both surface regions to varying amounts. The sign of selectivity simply indicates the region of greater film deposition.

When the amine surface is treated at pH 5.0 before stamping (FIG. 4a), (PAA/LPEI) multilayers adsorbed preferentially on the EO-MAL region. This effect is probably caused by hydrolyzed anhydride groups on the underlying amine surface. When these acid groups are present in large concentrations in the EO-MAL brush layer, the (PAA/LPEI) multilayers tend to adsorb in larger quantities on the partially ionized acid/EO-MAL surface rather than the amine surface. At pH 7.0 (FIG. 4b), a transition is observed, in which a greater amount of adsorption is actually found on the amine surface regions, although adsorption is sparse and irregular on both surfaces. The total amount of multilayer film adsorbed on this surface is relatively low, perhaps due to ionization effects at the surface which may affect the first few bilayers to yield flatly adsorbed polyion chains and sparse deposition on the surface. The large surface roughnesses also suggest incompatibility between the adsorbed multilayers and the aminopropylsilane SAM/SiO2 surface. When the pH was increased to 10 for the amine surface treatment prior to stamping, very thick (PAA/LPEI) films were deposited almost exclusively on the amine surface (FIG. 4c). EO-MAL exhibited the highest resistance to polyelectrolyte adsorption under these high pH conditions, implying the highest extent of amide formation from EO-MAL anhydride groups and amino groups on the surface. These results indicate that EO-MAL reacts more efficiently with the amine surface at higher pH, as expected, and hence can resist adsorption more effectively. The greater film thicknesses observed in the pH 10 sample may be due to the lowered degree of ionization of the surface; similar results have been reported in other work. Shiratori, S.; Rubner, M. F. Macromolecules 2000, 33, 4213-4219. The (PAA/LPEI) multilayer seems to dewet the amine surface and shrink to the center of the dot region. This dewetting effect is probably due to weakened electrostatic interactions between the amine surface and the polyion multilayers, combined with an inherent tendency of the relatively hydrophilic polyion pair to dewet the aminopropylsilane surface. Such dewetting did not occur when (SPS/PDAC) multilayers were adsorbed using the same preparation conditions (shown in FIG. 4d). SPS and PDAC are fully charged regardless of pH; the more hydrophobic nature of the SPS and PDAC backbones may have also made the multilayer film more compatible with the underlying SAM.

3. Patterning EO-MAL on Polyion Multilayer Surfaces: Templating Effects

The results observed with propylaminosilane model surfaces indicate that the resist properties of EO-MAL via pH treatment of the model amine SAM surface prior to stamping can be controlled. Similar behavior is expected on a polyamine surface. Therefore, EO-MAL templates can be used on various substrates by first creating a polyelectrolyte platform via adsorption of one or more polyion multilayers, followed by EO-MAL stamping.

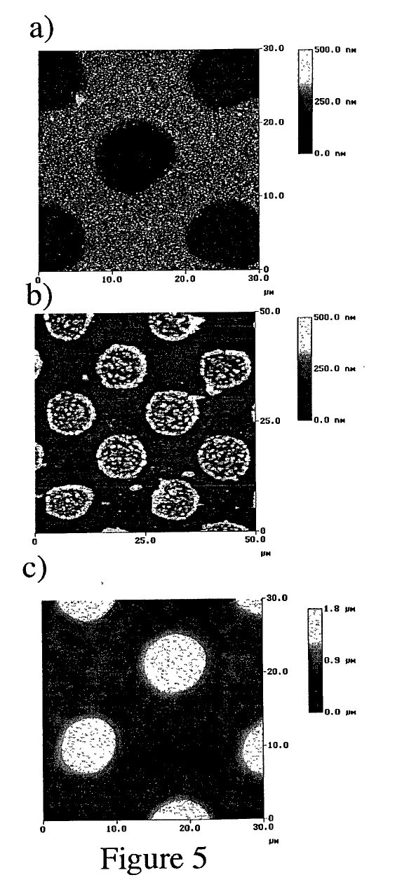

Five and one half (BPEI/PAA) bilayers were co-adsorbed onto a COOH SAM on Au or on a piranha solution cleaned Si substrate, with BPEI as the outermost layer. These platform layers were then stamped with EO-MAL, and SPS/PDAC multilayers were adsorbed onto the resulting chemically patterned surface of the BPEI/PAA base layers; typical results are shown in FIGS. 5a and b. FIG. 5a indicates negative deposition of (SPS/PDAC) multilayers induced when EO-MAL was stamped on a (PAA/BPEI) platform that was prepared with both PAA and BPEI solutions at pH 5. FIG. 5b illustrates that the EO-MAL template directed positive deposition of (SPS/PDAC) multilayers when the (PAA/BPEI) platform film was prepared from a BPEI solution at pH 7.0 and a PAA solution at pH 4.5. Ellipsometry results of continuous films on Si substrates show that when the polyelectrolyte platform is prepared at these pH conditions, the EO-MAL exhibits excellent resist qualities for (SPS/PDAC) multilayers; the EO-MAL surface contains only negligible amounts of adsorbed film on the surface. It is assumed the effectiveness of the EO-MAL monolayer as a resist is dependent on the formation of dense, brush layers, and the elimination of large quantities of unreacted, hydrolyzable anhydride groups. The effects seen in this experiment suggest that the pH of the platform layers is very important to the nature of the top BPEI surface, and thus the reactivity of the amine surface to the EO-MAL. Studies of polyion multilayers from poly allylamine hydrochloride (PAH) and PAA have indicated that the density of functional groups on the surface can be manipulated by changing the pH of the adsorption solutions. Shiratori, S.; Rubner, M. F. Macromolecules 2000, 33, 4213-4219.

To demonstrate the use of a completely non-metallic substrate, multilayers were also adsorbed onto hydrophilic polystyrene slides to form (PAA/BPEI) base layers, which were then stamped with EO-MAL. In this case, the (PAA/BPEI) platform was layered at pH5 onto the polystyrene surface and stamped; 15 bilayers of (SPS/PDAC) were deposited on the stamped surface to gain positive deposition (shown in FIG. 5c). These results are in contrast to the negative deposition observed for the system in FIG. 5a. On the other hand, the underlying substrate appears to have some influence on the top amine surface, despite the presence of five intermediate polyion bilayers. Several other researchers have observed surface effects in the build up of layer-by-layer films for the first three to ten polyion pairs. These effects may be due to compensations of charge at the surface, and thus depend on the relative charge of the underlying surface. If the top BPEI layer is more highly charged, it will-be less reactive to EO-MAL. The relatively uncharged polystyrene substrate seems to result in adsorbed multilayers which are less highly charged at the top surface, possibly due to differences in the dielectric environment near the substrate surface. This surface can be stamped with EO-MAL and resulted in effective resist surface even with the multilayer platform prepared at the relatively low pH of 5.0, unlike the more highly charged SAMs prepared surfaces. It is also noteworthy that thicker films are obtained on the polystyrene substrate, presumably due to the adsorption of thick, loopy polyion layers on the weakly charged surface.

4. Complex Microstructures Formed by Stamping EO-MAL on Patterned Sufaces

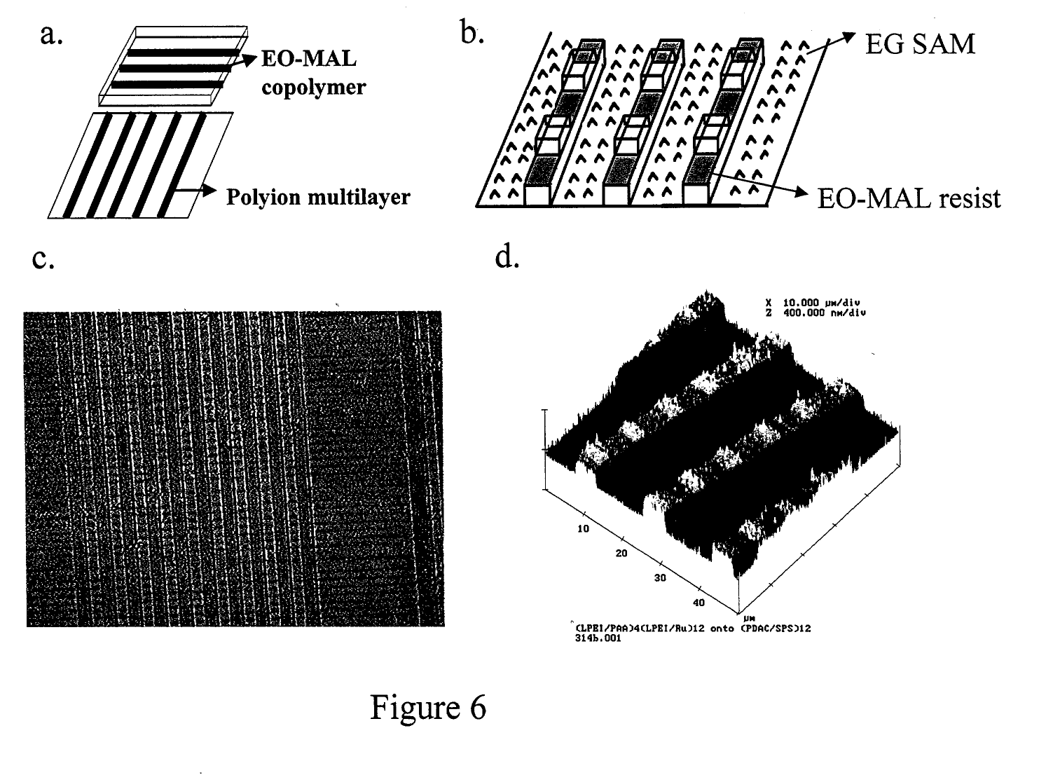

One of the key goals of this invention is to create methods for multiple level patterning of electrostatic multilayer films. In accomplishing this task, for example, a number of functional systems can be incorporated into the alternating layers of a multilayer film, and a second set of polymer multilayers can be patterned atop the original system. To demonstrate this general principle, EO-MAL can be stamped directly onto a set of existing patterned polyion multilayers (FIG. 6a). Further deposition of polyelectrolyte layers results in deposition only on the regions which the stamp did not contact, forming the dimensional heterostructure shown in FIG. 6b. To achieve this structure, the patterned multilayer base film was fabricated using the chemically templated ionic multilayer assembly technique originally described by our group using patterned SAMs. FIGS. 6c and 6d show the optical micrograph and AFM images of a complex heterostructure constructed using this approach. Two different stamps with stripe features of different widths and spacings were selected for patterning. 12 bilayers of (PDAC/SPS) were first selectively adsorbed on the COOH SAM of a patterned (COOH/EG alkanethiol) gold substrate to produce the broader stripes seen in FIG. 6c. The adsorption of polyion multilayers is followed by a 30 minute immersion in BPEI solution at pH 8 to obtain a reactive polyamine top layer on the original set of stripes. The EO-MAL ink was then stamped to produce a set of more narrowly spaced lines perpendicular to the (PDAC/SPS) stripes by allowing the stamp to contact the surface for 1 hr. Following the stamping of the EO-MAL resist, 4 bilayers of (LPEI/PAA) and 12 bilayers of LPEI and a sulfonated ruthenium dye were deposited as periodic squares on the (PDAC/SPS) stripes. In this case, the wider regions are the regions containing EO-MAL, and the narrower regions were left unfunctionalized, and were therefore surfaces which allowed deposition of the LPEI/sulfonated ruthenium dye system.

The surfaces of a large number of substrates can be readily coated with multiple layers of common polyelectrolytes such as BPEI based on electrostatic or secondary interactions; this approach utilizes the printing of such thin films as a basis for patterned chemical modification. The flexibility of this technique makes it extensible to plastic films, fibers, and numerous other substrates. The ability to create chemical patterns on common surfaces such as plastic and glass without expensive or time consuming substrate pretreatment could lead to a range of applications. Furthermore, the layer-by-layer assembly process accommodates the inexpensive, aqueous phase processing of lightweight, functional thin film devices. By being able to pattern atop a previously defined pattern, we have introduced the capability of multi-level microfabrication. The vertical heterostructures presented here are an example of complex two and three dimensional structures currently under investigation in our group. In general, the interactions between polyions and surfaces can be tuned and manipulated using adsorption conditions and directed or templated deposition to achieve the desired structure.

Rubner and coworkers have shown that the thickness, surface functional group density and morphology of the continuous polyelectrolyte platform can be controlled by the pH of the adsorption solution for weak polyelectrolytes. Shiratori, S.; Rubner, M. F. Macromolecules 2000, 33, 4213-4219; and Yoo, D.; Shiratori, S. S.; Rubner, M. F. Macromolcules 1998, 31, 4309-4318. By controlling the thickness and the density of amino groups in the polyamine outermost layer, EO-MAL can be completely converted to amide linkages, resulting in a more efficient oligoethylene oxide resist layer. Also, other molecules can be used in place of EO-MAL, such as PEG derivatives containing electrophilic groups reactive towards amines, or block copolymers with a short electrophilic block and a long PEG block.

Stamping Block Copolymer, Graft Copolymer, and Polyelectrolytes

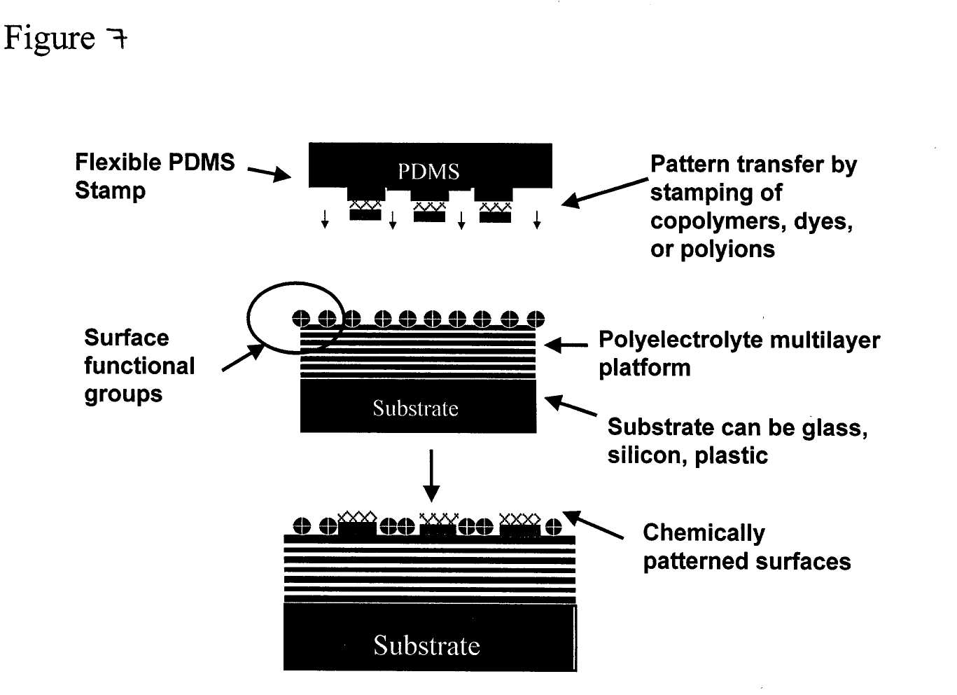

Two embodiments of the polymer-on-polymer stamping approach are described here: stamping of block copolymers; and stamping of charged polyelectrolyte homopolymers (see FIG. 7). In the first approach described here, a block copolymer containing numerous weak acid groups (PAA) and a nonreactive, uncharged polymer block (polystyrene) is directly transferred to amino functional surfaces. The resulting surfaces were then examined as a function of temperature and pH pretreatment to determine optimal conditions for stamping. In this case, the polyacrylic acid block undergoes secondary and covalent interactions with the underlying amine surface. The nature of attachment of the polymer to the surface can also be based solely on ionic interactions; to demonstrate this effect, in another portion of this disclosure the direct transfer of a positively charged homopolymer to a negatively charged substrate, illustrating the universal nature of the polymer stamping approach and the range of interactions which can be used to produce a chemically patterned polymer surface, is explored.

1. Block Copolymer Stamping

Initial investigations of polymer-on-polymer stamping involved the transfer of alternating copolymers of maleic anhydride and poly(ethylene glycol) functionalized methacrylates to the amino functional surface of a polyelectrolyte multilayer. In this case the basis of the functionalization was the use of an anchored polymer backbone with grafts of PEO oligomers extending from the backbone. The use of a block copolymer containing an anchoring block and a second, surface functional block, should also lead to a means of producing dense high molecular weight polymer layers on surfaces. A 10 mM solution of a polystyrene-polyacrylic acid diblock copolymer (PS-b-PAA) in tetrahydrofuran was used to ink a polydimethylsiloxane (PDMS) stamp. After the excess solvent was removed from the stamp surface through nitrogen or air drying, it was placed on the substrate and allowed to remain in contact for 10 minutes. The acid groups on the PAA block are capable of undergoing dipole-dipole, hydrogen bonding, or ionic interactions with the amino groups on the underlying substrate, as well as covalent bonding through the formation of amide groups.

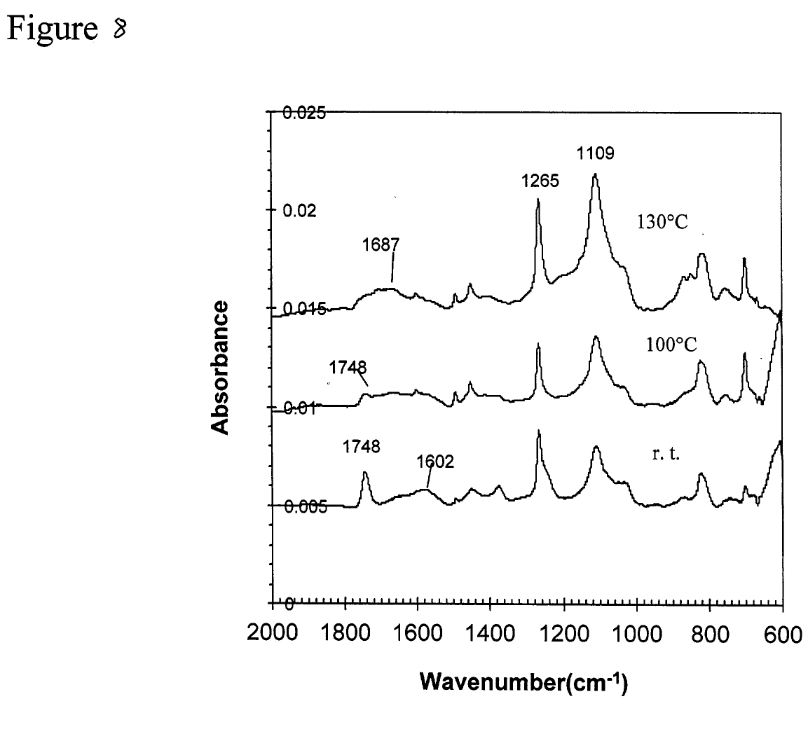

The effects of temperature and pH pretreatment on the nature of bonding of the PS-b-PAA block copolymer to the surface was examined with blank, featureless stamps which were made on a clean Si wafer. To investigate the effect of temperature using FTIR, it was necessary to eliminate the IR absorption from the polyelectrolyte multilayer platform; this was done by using a single layer of PAH directly adsorbed onto a gold substrate from a 10 mM aqueous PAH solution (concentration based on repeat unit) at pH 8.6 overnight. The adsorption of a PAH layer was confirmed by ellipsometry (13 Å thick) and grazing angle FTIR. The substrate was then used as a stamping platform to avoid absorption from multiple polyelectrolyte layers in the FTIR spectra. PS-b-PAA was stamped onto the PAH layer at room temperature, at 100° C. and at 130° C. respectively by holding the substrate with the stamp in an oven at the appropriate temperature for 10 minutes. The stamp was then removed and grazing angle FTIR (GA-FTIR) was conducted. The results at each stamping temperature are shown in FIG. 8. The GA-FTIR spectra illustrate that the nature of bonding of PS-b-PAA on the polyamine surface changes with the temperature. As the stamping temperature is increased, the carbonyl stretch band shifts from 1748 cm⁻¹, characteristic of the acid COOH to 1687 cm⁻¹, characteristic of the amide CONH. These measurements indicate that the acid groups in the PAA block of the PS-PAA block copolymer undergo condensation reactions with the primary amine groups in the underlying PAH film at higher temperatures. The differences in GA-FTIR suggest that block copolymer monolayer adsorption is based primarily on secondary interactions such as hydrogen bonding between amine and acid groups at low temperature; whereas at high temperature, more stable covalent bonds form between the acid groups of the PAA blocks and the amino groups of the surface.

Differences in the nature of the bound block copolymer layers as a function of the stamping temperature were also measured with advancing contact angle measurements with water (see FIG. 3—“as stamped”). Untreated aminosilane SAM surfaces with unprotonated primary amine groups were used as a stamping platform for contact angle stability studies in order to avoid unwanted effects due to desorption or other changes in the polyelectrolyte multilayer platform itself under different solvent conditions. Literature data for the advancing contact angle of polystyrene homopolymer with water range from 87° to 90°; whereas the contact angle of polyacrylic acid is approximately 15° to 20°. Wu, S. Journal Polymer Science, Part C 1971, 34, 19; Kwok, D. Y.; Lam, C. N.; Li, A.; Zhu, K.; Wu, R.; Neumann, A. W. Polymer Engineering Science 1998, 38, 1675; Shiratori, S.; Rubner, M. F. Macromolecules 2000, 33, 4213-4219. The high contact angle data in FIG. 3 indicate that the PS block is segregated from the underlying PAA block, presumably due to large adhesive secondary interactions as well as covalent bonding of the PAA to the amino groups on the platform. When the PAA block is only partially bound to the substrate, re-arrangements of the PAA block or the presence of unbound PAA segments will result in lowered contact angles with water due to the hydrophilic nature of PAA. The data indicate a continuous increase in the water contact angle with increasing stamping temperature. The data obtained for the monolayer stamped at 130° C. has a contact angle approaching that observed on a control thin polystyrene homopolymer film spincast on silicon of 102°. This data confirms that the higher the stamping temperature, the greater the number of PAA segments bound on the amine surface due to the formation of covalent amide bonds as discussed above. The result is a consistent trend of higher contact angles with higher stamping temperatures.

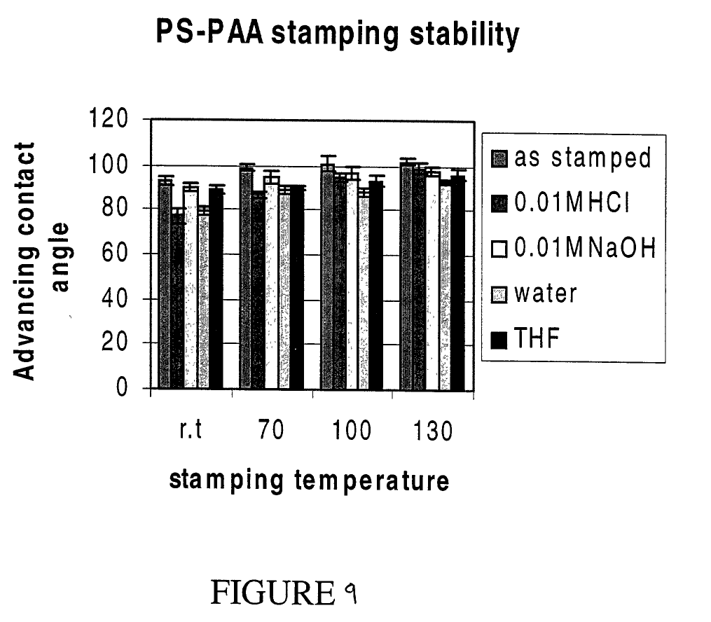

The stability of PS-b-PAA block copolymer films which were contact printed at different temperatures was tested by immersing each sample into each of four different solvent conditions: 0.01M HCl (pH=2.0) for 10 minutes, 0.01M NaOH (pH=12.0) for 10 minutes, deionized water for 20 hours, and THF for 10 minutes. These solvent systems were chosen because they present competing hydrogen bond and polar interactions that can weaken secondary interactions between the PAA block and the amine surface. Following immersion in a given solution or solvent, the surface was dried to remove excess solvent, and the contact angle with water was measured immediately and compared to the contact angle measured before the stability test. These results are shown in FIG. 9; it is important to note that the x-axis represents the temperature at which the polymer was stamped. All solvent systems were kept at room temperature. In general, it was found that exposure to aqueous solutions or polar solvents such as THF leads to slightly lower contact angles under all stamping temperatures, indicating that secondary interactions play a role in adhesion of the layer under all conditions. This increase in surface energy is due to rearrangements of the block copolymer on the surface, which expose hydrophilic acid groups to the surface. The introduction of covalent bonds via amidation at high temperature prevents some of these rearrangements; the result is a more stable monolayer, as indicated by the increase in contact angle with increasing stamping temperature for each solvent condition shown (0.01 M HCl, .01 M NaOH, pure deionized water, pure THF).

In was found previously that covalent bonds can be encouraged in the stamping of the anhydride-vinyl ether graft copolymer by treating the surface prior to stamping with high pH aqueous solution. Jiang, X.-P.; Hammond, P. T. Langmuir 2000, 20, 8501-8509. The amino groups are most reactive in their unprotonated form, and can more readily undergo condensation with acid or anhydride groups to form amide bonds. To examine the effect of pH pretreatment of the platform surface prior to stamping the PS-PAA block copolymer, an aminopropylsilane SAM on a Si substrate was used as a stamping platform. The aminosilane SAM substrates were immersed into 10 mM concentrations of pH 2.5, pH 5, pH 7, and pH 10 buffer solutions for 5 minutes and then dried under a dry N₂ stream. PS-b-PAA block copolymer was stamped on the aminosilane SAM at room temperature for 10 minutes, and contact angle measurements were performed with water on the stamped surface.

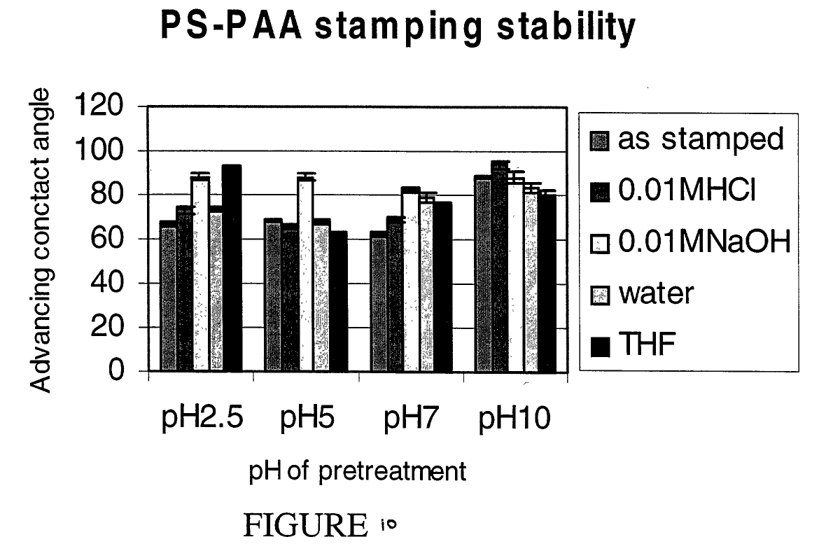

FIG. 10 contains data on PS-PAA block copolymers printed on platforms with various pH treatments. The contact angle of the transferred block copolymer prior to any solvent exposure (FIG. 10—“as stamped”) was relatively low at approximately 65° at low and intermediate pretreatment pH values, indicating the presence of many free acid segments from the PAA block accessible at the surface. It was not until a pretreatment pH of pH 10, above the pKa of the primary amine groups on the surface, that the contact angle increased to greater than 85°. Several possible adhesive interactions can dominate in the stamping process: ionic interactions between oppositely charged surface amine groups NH₃⁺ and carboxylate groups COO⁻ from PAA due to acid/base exchange, simple polar-polar interactions between NH₂/NH₃⁺ and COOH/COO⁻, hydrogen bonding, and ultimately covalent bonds. The polar-polar and hydrogen bonding interactions are important and may well dominate the adhesion for polymers stamped at low temperature. The formation of some covalent bonds likely contributes to film stability when the substrate is treated to high pH. In this case, the primary amine groups on the platform surface are densely packed and highly reactive; therefore it is likely that some reaction occurs with the COOH groups of the block copolymer and the amine surface. Although the extent of this reaction may be relatively small, even small degrees of covalent bonding at the surface can lead to much more stable monolayers. This is also consistent with the findings of the stability test: the contact angles actually increased after the samples were soaked in basic 0.01 M NaOH, which has a pH of 12. The introduction of basic aqueous or solvent conditions may have increased the reactivity of free protonated surface amine groups, allowing them to undergo stronger interactions or reactions with acid groups, as in the case of NaOH and THF soaks. In general it was found that a THF rinse of the platform after stamping also tends to make the PS-b-PAA layer smoother and more uniform, and increases monolayer stability to post-treatment, probably because the organic solvent also stabilizes the surface segregation of the PS block at the air interface instead of the amine surface. Exposure to acidic conditions had little or at best a very small effect on the contact angle of the transferred films when compared to the as-stamped samples; small increases in contact angle may be due to small changes in hydrogen bonding between acid and amine groups in acidic conditions. It is notable that only when the surface pretreatment is at pH 10, when some of the polymer chains become covalently bound and a more stable monolayer is formed, that the as-stamped monolayer appears more stable than monolayers exposed to various polar solvents.

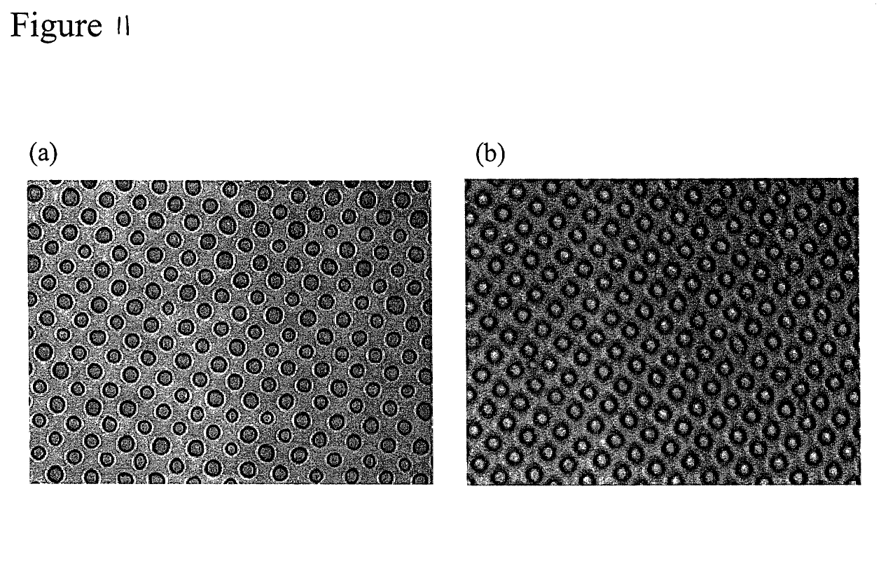

To illustrate the ability to directly micropattern with the block copolymer, water condensation images were formed from the alternating hydrophobic/hydrophilic surface regions of a stamped PS-b-PAA monolayer on the amine or polyamine surface. This procedure was demonstrated earlier by Kumar et al. for patterned alkanethiolate SAMs on gold surfaces. Kumar, A.; Biebuyck, H. A.; Whitesides, G. M. Langmuir 1994, 10, 1498-1511. FIG. 11a illustrates a condensation figure formed from stamping of the PS-PAA block copolymer at room temperature, onto an aminosilane SAM without any pretreatment. The pattern of hydrophobic versus hydrophilic regions delineated by the water droplets illustrate a very clean, well-defined pattern. The diameter of the circular features shown is 10 microns. To demonstrate the successful stamping of PS-PAA onto a polymer multilayer surface, a strong polyelectrolyte platform of SPS/PDAC was formed on glass slides, followed with a top polyamine layer of PAH adsorbed at pH=8.5 (shown in FIG. 11b). In both cases, a clear image is observed under the microscope of water droplets condensed and pinned on the surface. The outer regions contain the hydrophobic PS surface functional groups, whereas the 10 micron dots are the unstamped, hydrophilic amino regions which are readily wet by water. These images illustrate that the transfer of the polymer to the surface was effective and reproducible, even at room temperature and using relatively short stamp contact times, and can be done to micron resolution using a PDMS patterned stamp.

2. Polyelectrolyte Stamping

The interactions between acid and amine groups during the stamping process can be optimized by varying pH or stamping temperature to encourage the formation of covalent bonds. Strong oppositely charged polyelectrolytes such as SPS and PDAC are highly ionized over all or most of the pH range, and will only undergo ionic interactions with each other. These systems are ideal for examining the transfer of charged polymers onto an oppositely charged substrate based solely on ionic interactions. In the study reported here, PDAC was stamped directly onto an outermost SPS layer of a PDAC/SPS multilayer film. The stamped regions were characterized using ellipsometry and AFM, as well as fluorescence microscopy, as will be discussed below.

Characterization of Transferred Monolayer Thickness

Microcontact printing of polymer systems involves the physical transfer of the polymer to a functional surface; under most circumstances, the material transferred by the stamp exceeds that of a single functional polymer monolayer. The excess polymer is then rinsed away with an appropriate solvent, leaving an adsorbed monolayer of the polymer on the surface. It is this single functional monolayer which is of interest for applications involving the chemical patterning of surfaces. Similar approaches are used in the transfer of common low molar mass monolayer forming systems such as silanes and alkanethiols using microcontact printing.

The polymer film transferred during the stamping of polyelectrolytes on surfaces is particularly thick due to the large cohesive interactions between polymer chains, and the viscous nature of the high molecular weight polymer. This thick layer is easily rinsed away with water, leaving the only the desired functional monolayer of interest strongly adsorbed to the surface. To determine the amount of material transferred during the stamping process, a gold substrate was treated with an COOH SAM, over which five-bilayer platforms of PDAC and SPS were adsorbed. The thickness of these platforms was roughly 200 Å before and after rinsing of the multilayer sample platforms. On top of these platforms, a print was made from a blank (unpatterned) stamp, using the optimized procedure described above (0.25M PDAC, in 75/25 ethanol/water for 1 minute). The statistical average thickness of the transferred layer is notably similar to the average thickness of 20 Å observed for a single adsorbed polyelectrolyte monolayer in the layer-by-layer adsorption process. This observation suggests that the transferred layer may be similar to that obtained using adsorption from solution. This observation provides an interesting comparison between polyelectrolyte layers adsorbed from dilute solution, and those truly adsorbed during the stamping process; this topic is a part of ongoing studies.

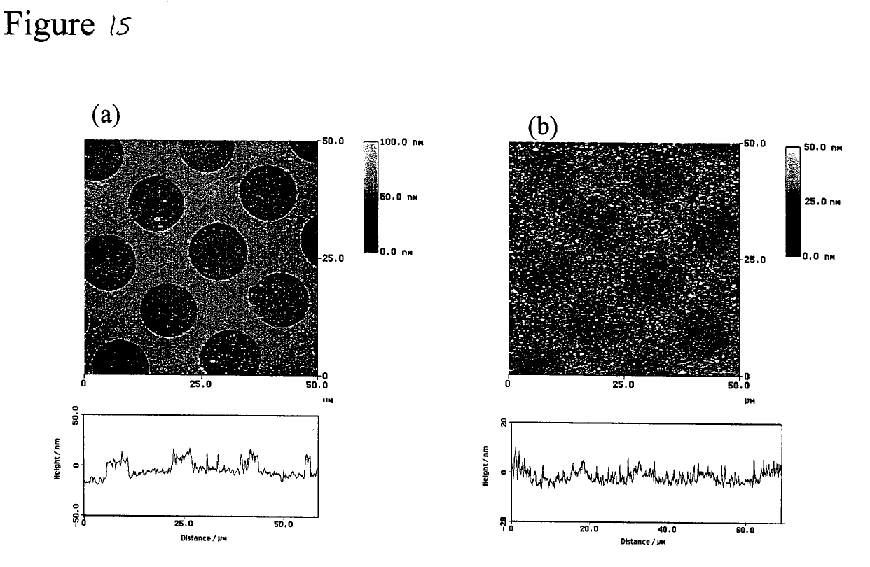

This data is consistent with AFM images taken of PDAC, in this case stamped from aqueous solution. The AFM of the surface before and after rinsing is shown in FIG. 15a) and b). Prior to rinsing, the thickness of the stamped polymer layer shown is about 16 nm on average; following the rinsing process, the remaining polymer film is only 3 to 4 nm in height, a number which is again consistent with the range of thicknesses observed in polyelectrolye multilayer adsorption. Interestingly, a clear and sharp image is obtained in both cases. The AFM is able to detect topographical differences in the film to image the patterned polymer monolayer; unfortunately, the surface roughness of the polyelectrolyte multilayer approaches and in many cases surpasses the thickness of the polymer monolayer, resulting in a great deal of noise in the final images, and making the AFM a less effective tool in imaging the actual chemical pattern produced using this method. For this reason, fluorescent imaging has been used to image the transferred polymer monolayers on the surface.

Optimization of Stamping Process

To image regions of alternating positive and negative charge, stamped multilayer samples were stained with a negatively charged fluorescent dye, 6-CF (6-carboxyfluorescein, from Sigma) for a few seconds to no more than five minutes, and sonicated for two minutes in water. Caruso, F.; Lichtenfeld, H.; Donath, E.; Mohwald, H. Macromolecules 1999, 32, 2317-2328. They were then examined in a fluorescence optical microscope. The resulting prints produced were stable, and could be viewed weeks later with no change in appearance. All of the fluorescence images discussed in the following sections are of printed regions which were rinsed after stamping, indicating the presence of alternating charge on the surface region due to the presence of a single monolayer of adsorbed polymer.

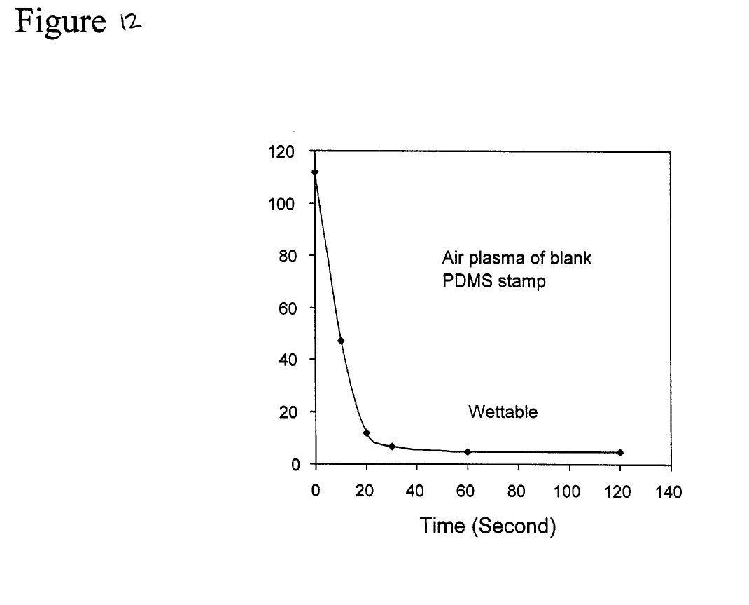

Details of the stamping optimization process given here include information on the role and range of solvent choice, concentration, and stamp exposure times applicable to the microcontact printing of a simple polyelectrolyte system. To be able to transfer charged or highly polar inks to the surface, it was necessary to treat the PDMS stamp with air plasma. Plasma times of 15 seconds or longer are sufficient to make the stamp wettable, as determined by contact angle measurements of a blank PDMS surface (see FIG. 12), which indicates a strong drop in contact angle of the PDMS surface at 15 to 20 seconds. The strong polyelectrolyte PDAC was stamped from dilute aqueous solutions and from water/ethanol mixtures at higher concentrations. We also found that SPS can be stamped onto PDAC surfaces. Patterning can be achieved from very dilute polyelectrolyte solutions using aqueous inking solutions containing 0.02M PDAC with 0.1M NaCl added as ink and 30 minutes of stamping time, provided that the PDMS stamp was plasma treated for 15 seconds. Similar results were observed with the stamping of SPS on a PDAC surface of an PDAC/SPS film using a 0.01M SPS aqueous solution with 0.1M NaCl as ink, 30 seconds of air plasma for the PDMS stamp, and a 30 minutes stamping time.

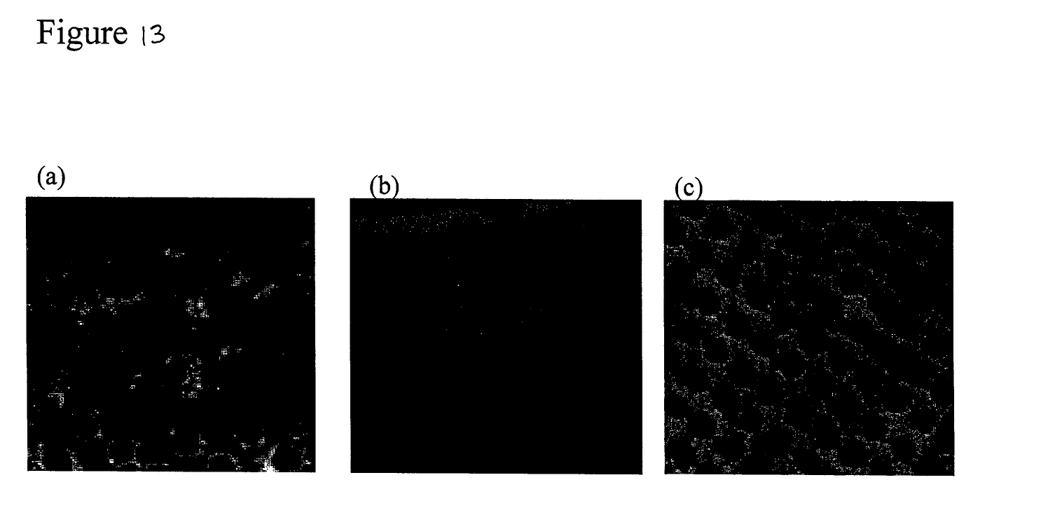

PDAC was also successfully stamped from concentrated solutions in water/ethanol mixtures at much shorter stamping times. Ethanol is a promising solvent because it is at once polar and volatile, which suggests that it can easily solubilize PDAC, yet it evaporates rapidly from the stamp, preventing “bleed” during the stamping process. Neither pure ethanol, nor a 25/75 by volume ethanol-water mixture produced good coverage of the polyelectrolyte. Insufficient coverage can produce black areas with no transferred film, or areas where only the edges of the pattern were transferred (rimming). This effect is shown in FIG. 13a. Solutions made in either 50/50 ethanol/water or 75/25 ethanol/water mixtures performed much better, with the 75/25 mixture giving uniform transferred polymer films, with well defined, clear edges. For most of these solutions, variations in coverage on the stamp during the inking process often produced streaks similar to brush strokes, as pictured in FIG. 13b.

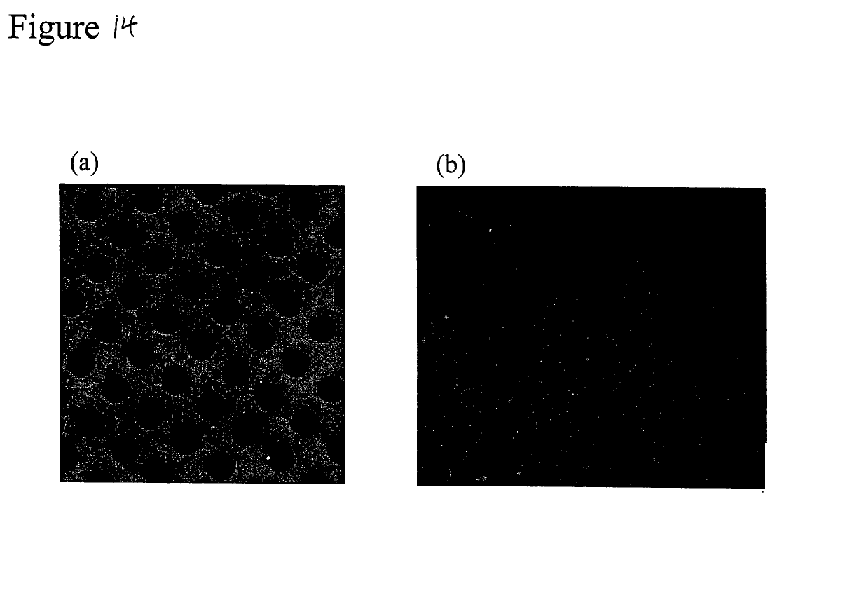

A wide variety of stamping times were tried—ranging from a few seconds to an hour. At longer stamping times, the stamp tended to adhere to the platform, making it difficult to remove. Due to this phenomenon, the resulting printed areas displayed cracked surface regions (see FIG. 13c). Shorter stamping times reduced the sticking, as did lighter coatings of ink. At very short stamp times (a few seconds), no PDAC was transferred to the platform. These results indicate that there is an optimal contact time for printing; for PDAC/ethanol solutions, optimal times were found at thirty seconds to one minute that resulted in good prints without great difficulty in removing the stamp. A number of concentrations of PDAC were also attempted using the ethanol/water solvent mixtures. Low concentrations (0.025M) produced poor or no transferred prints at all. Moderate concentrations (0.1M) performed well, but high concentrations (0.25M) performed best, giving highly uniform stamped regions over large areas. Based on the variables discussed above, the optimal stamping condition for PDAC was determined to be a 0.25M solution of PDAC in a 75/25 ethanol-water mixture, stamped for one minute. This set of conditions is markedly different from the successful aqueous stamping conditions, which work best at dilute concentrations and longer stamping times. Images are shown for samples stamped using optimal conditions from ethanol/water mixtures in FIG. 14. The presence of an alternating positive/negative pattern is made clear by the presence of the green dye on the positive PDAC regions. The dark black regions are the underlying SPS layer, which repels the dye because of electrostatic repulsion. It is clear that there is no bleed or unwanted transfer of PDAC in the SPS regions of the pattern, indicating a clean pattern transfer. A uniform layer can such as the one shown can be created over large areas. We have successfully patterned micron-sized features over approximately a centimeter square area; the possibility of patterning over large areas is therefore reasonable using this approach.

Patterned Conducting Films

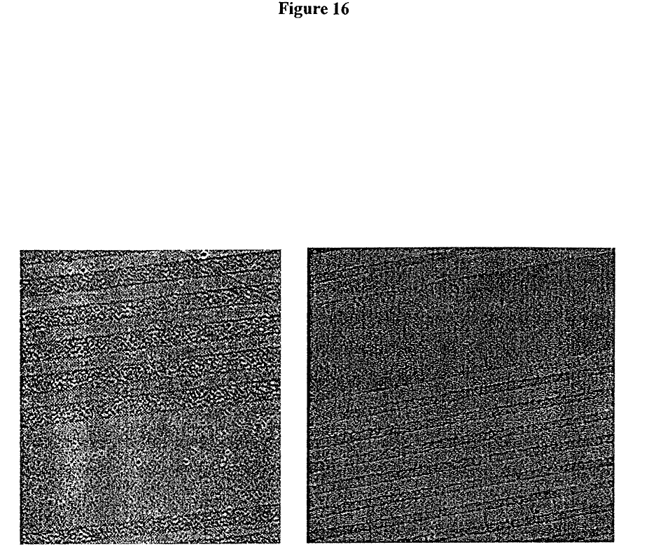

An area in which the techniques described above will be applied toward practical problems is the creation of conducting polymer electrodes of micron scale dimensions. At this time, both polyaniline and the transparent conducting polymer, PEDOT, are the current focus of these investigations, although other conducting polymers may also be examined. Here the real challenges involve achieving unusually high adsorption selectivity on the surface. Conducting polymers are of particular interest for applications in which flexibility is an issue, such as Mylar substrates. Metal conducting films may also prove quite useful for this application, and these challenges apply to metal plating as well. Interest in the ability to pattern electrodes on a micron to submicron level has been expressed as a need from a number of different industries. Very recent preliminary results show that we can effectively pattern polyelectrolyte multilayers containing PEDOT (Baytron P suspension with SPS) utilizing alternating COOH/EG functional surfaces, as shown in FIG. 16. Similar results have been found with polyaniline (PANi) multilayer thin films. At this time, we are continuing to investigate a number of conducting polymers using selective deposition onto patterned substrates. It is our plan to investigate plastic and silicon substrates using the polymer-on-polymer method to create chemical templates for multilayer depositon. Four point probe conductivity measurements will be carried out to determine the electronic conductivity of these films.

As mentioned for the OLED and other systems, we can also use polymer-on-polymer stamped surfaces as templates for spin cast or solvent cast films of conducting polymers. MacDiarmid and coworkers have shown that alternating hydrophobic and hydrophilic regions of a surface can be used as a means of controlling the morphology of polyaniline deposited on the surface from solution, creating many orders of magnitude difference in the conductivity of films on the hydrophobic versus hydrophilic regions of the surface. In this work, the resolution of patterning was in the range of millimeters. Here we can examine similar effects with micron scale resolution to create patterned conducting films. The concepts of wetting/dewetting on films such as that shown in FIG. 12 will also be investigated with PEDOT cast films. Electrodes will be tested using traditional four point probe measurements, as well as by incorporation into simple devices, such as OLED devices. Finally, we can directly stamp charged conducting polymers onto surfaces to form patterned conducting thin films. The thickness and uniformity of these directly stamped layers will be evaluated and compared to films formed from selective adsorption or spin casting on patterned templates.

POPS as a Template for Other Materials Deposition

The chemically templated surfaces formed using polymer-on-polymer stamping can be used to direct materials deposition onto glass, metal, semiconductor, and plastic surfaces. By selecting a block or functional polymer with a given interaction or reactivity, various materials deposition processes will be examined. One example of materials deposition is metal plating. Early investigations have shown that polymer-on-polymer stamping can be used to template electroless plating on polymer surfaces.

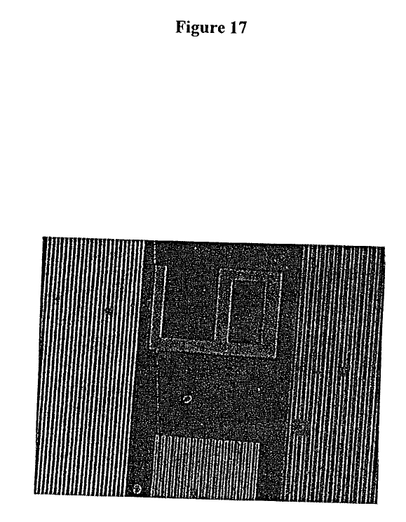

In this work, electroless plating chemistry was applied to stamped polyelectrolyte multilayer surfaces. An oligoethylene oxide allyl ether-maleic anhydride alternating copolymer (EO-MAL) was stamped atop the PAH surface of a PAA/PAH multilayer. When the substrate is immersed in the catalyst bath, followed by the Ni plating bath, only the regions that were stamped are plated, resulting in a patterned metal film with high edge resolution and fidelity to the original pattern, as seen in FIG. 17. This approach provides a simple means of creating micron scale patterned metal regions for electrodes and device applications atop an existing polyelectrolyte multilayer. What is particularly attractive about this approach is that the multilayer may contain a functional system of interest, such as chromic or luminescent films for devices. Further, simple plastic surfaces may be treated with a single or a small number of polyion bilayers, and subsequently patterned without the use of elaborate surface treatments.

New materials systems which may be of interest include the patterning of catalysts or precursors for ceramics, including silicates, which might act as insulators or dielectrics. For example, polyethylene oxide and other water soluble polymers are known to sequester silica precursors such as TEOS (tetraethylorthosilicate) in aqueous solution. Utilizing a hydrophobic block copolymer such as PS-PAA, hydrophobic and hydrophilic regions might be patterned onto a multilayer surface. TEOS may then be infused into the surface layer through aqueous adsorption and diffusion. Subsequent introduction of an acidic catalyst should seed the production of silicates on specific regions of the surface. The formation of patterned silica is of interest, as silica may have interesting properties as an inert or insulator material. Silica is also a good candidate material for initial studies of ceramic templating, as the chemistry is fairly well known and understood, and the resulting materials should be straightforward to characterize. Other ceramic systems and oxides may also be investigated in this work.

Exemplification

The invention now being generally described, it will be more readily understood by reference to the following examples, which are included merely for purposes of illustration of certain aspects and embodiments of the present invention, and are not intended to limit the invention.

### EXAMPLE 1

Stamping Copolymers on a Surface to Serve as Templates for Additional Layers

Materials

Poly(acrylic acid) sodium salt (MW=20,000) (PAA), sodium poly(styrene sulfonate) (MW=35,000) (SPS), and linear polyethyleneimine (MW=25,000) (LPEI) were obtained from Polysciences. Polydiallydimethyl ammonium chloride (MW=100,000-200,000) (PDAC) and branched polyethyleneimine (MW=25,000) (BPEI) were obtained from Aldrich. All polyelectrolytes were used as received without further purification. Polyelectrolyte dipping solutions were prepared with 18 MΩ Millipore water, and the pH of these solutions was adjusted with either HCl or NaOH. The concentrations of all polyelectrolytes were 0.01 M as based on the molecular repeat unit of the polymer, with the exception of the PDAC solution, which was 0.02M. Solutions were filtered with a 0.45 μm Acrodisc syringe filter (Pall Corporation) to remove any particulates. The copolymer of an oliogethylene oxide functionalized vinyl ether and maleic anhydride (Mn=14,000) (EO-MAL) was obtained from Shearwater Polymers, Inc. The concentration of EO-MAL was based on the formula weight of the nominal repeat unit of maleic anhydride and oligoethylene oxide allyl ether, which is 1670. A 2 mM solution of EO-MAL in acetonitrile was used as an ink for the PDMS stamp. To obtain a sample of neat EO-MAL for Grazing Angle FTIR (GA-FTIR), a 2 mM methanol solution of EO-MAL was used to cast continuous films onto zinc selenide plates. Aminopropyl trimethoxy silane was obtained from Aldrich and used as received. Poly(dimethylsiloxane) (PDMS) from the Sylgard 184 silicone elastomer kit (Dow Corning) was used to form stamps for micro-contact printing. The stamp used to make prints on the multilayers was a PDMS stamp. It was made by pouring a commercial PDMS mix (Sylguard, 184 silicone elastomer kit) over a silicon master etched with the desired pattern.

Substrate Preparation

Three different substrates were used. Silicon wafers(100, test grade) were obtained from Silicon Sense and were cleaned by immersion in a freshly prepared piranha solution of 70% conc. H₂SO₄(aq)/30% H₂O₂ (aq) (v/v) for 1 hr at 80° C. (Caution: piranha solution reacts violently with many organic materials and should be handled with care.) Gold substrates were prepared by electron beam evaporation of 100 Å Cr as an adhesion promoting layer, followed by 1000 Å Au onto silicon wafers. Gold substrates were rinsed by absolute ethanol, followed by N₂ blow dry right before use. Hydrophilic polystyrene (PS) cell culture slides were obtained from Nalge Nunc International and was rinsed by deionized water before use.

Micro-contact Printing and Layer-by Layer Assemblyfor Thiol SAM on Au Substrate

The microcontact printing method for alkane thiols on gold was followed as described by Kumar et al. (ref Whitesides again). The stamp was fabricated by casting poly(dimethylsiloxane) (PDMS) on a photolithographically prepared silicon master which was previously patterned with photo resist. The features of the photo resist pattern were replicated on the PDMS stamp surface after curing and the PDMS stamp can be peeled away and ready for use. A saturated solution of HS(CH₂)₁₅COOH (COOH SAM hereafter) in hexadecane was used to ink the stamp. After evaporation of the solvent, the PDMS stamp was briefly dried under N₂ stream and was brought in contact with the substrate for 1 minute. The stamp was carefully peeled off and the substrate was rinsed with ethanol. The bare gold region was then functionalized with a second alkanethiol SAM HS(CH₂)₁₁(OCH₂CH₂)₃OH (EG SAM hereafter) by immersion into a 1 mM solution of the thiol in absolute ethanol for 1 minute. The sample was finally rinsed with absolute ethanol to remove the excess alkanethiol and dried with N₂. Following these steps, the layer-by-layer deposition process was carried out using an automatic dipping machine (HMS programmable slide stainer from Carl Zeiss). In all cases, the first polyelectrolyte adsorbed was the cationic species, which adsorbs directly to the ionizable COOH/COO— patterned SAM. Each adsorption cycle consisted of immersion of the substrates in the polyelectrolyte solution for 15 minutes, followed by 2 agitated rinses in rinse water bins (the pH was not adjusted for strong polyelectrolyte cases, but the rinse water pH was adjusted to match the polyelectrolyte solution pH for weak polyelectrolyte cases.) The substrates were then dipped into the oppositely charged polyelectrolyte solution, followed by the same rinsing procedure. The samples were cleaned for 4 minutes in an ultrasonic cleaning bath (custom designed, Advanced Sonic Processing System) following the deposition of each polycation/polyanion pair. This process was repeated to build up multiple layers.

Patterning of EO-MAL on the Amine Surface and Complex Microstructure Fabrication

Due to the polar nature of EO-MAL, the PDMS stamp was oxidized with O₂ plasma for 2 mins at 0.5 Torr and 50 sccm flow in a home-made plasma chamber to facilitate wetting of the stamp surface. The stamp was inked with EO-MAL solution shortly after plasma treatment. After inking with EO-MAL solution and drying under N₂, the stamp was placed in contact with the polyamine surface for 0.5-1 hr. Then the substrate was rinsed with ethanol to remove any excess material and used as a substrate in the polyion layer-by-layer process. In this case, the first layer adsorbed was always a polyanion, which can adsorb to the underlying positively charged polycation surface. The stamped regions were designed to act as resists to adsorption based on the oligoethylene glycol graft chains of EO-MAL. In the procedure of creating complex microstructures, EO-MAL was stamped onto a patterned polyamine surface, which was fabricated by the thiol SAMs templated ionic multilayer assembly described in the previous sub-section. The substrate was then used for the sequential adsorption layer-by-layer process as usual and new polyelectrolyte multilayers were built up outside the stamped region.

Characterization

AFM images were taken with a Digital Instruments Dimension 3000 AFM in tapping mode. Grazing angle FTIR (GA-FTIR) spectra were obtained in single reflection mode using Digilab Fourier transform infrared spectrometer (Biorad, Cambridge, Mass.). The p-polarized light was incident at 80° relative to the surface normal of the substrate, and a mercury-cadmium-telluride (MCT) detector was used to detect the reflected light. A spectrum of a SAM of n-hexadecanethiolate-d33 on gold was then taken as a reference. Laibinis, P. E.; Bain, C. D.; Nuzzo, R. G.; Whitesides, G. M. J. Phys. Chem. 1995, 99, 7663-7676.

### EXAMPLE 2

Stamping Block Copolymer, Graft Copolymer, and Polyelectrolytes

Materials

Poly(diallyldimethylammonium chloride) (PDAC) of MW=150,000 was purchased from Aldrich. Sulfonated polystyrene (SPS) of MW=70,000 was obtained from Aldrich. Poly(allylamine hydrochloride) (PAH) of MW=50,000-65,000 and poly(acrylic acid) (PAA) with MW=90,000 were purchased from Aldrich; polystyrene-polyacrylic acid diblock copolymer (PS-b-PAA) with a PS block MW=66,500 and PAA block MW=4,500 was obtained from Polysource. The aminopropyltrimethoxy silane was also obtained from Aldrich. The stamp used to make prints on the multilayers was a PDMS stamp. It was made by pouring a commercial PDMS mix (Sylguard, 184 silicone elastomer kit) over a silicon master etched with the desired pattern.

### EXAMPLE 2

Stamping of PS-b-PAA block copolymer

Substrate Preparation

Three different substrates were used as platforms for the stamping of the PS-b-PAA block copolymer. Direct stamping onto polyelectrolyte multilayer substrates was demonstrated using 10(PDAC/SPS) bilayers adsorbed on glass slides, and capped with a final layer of PAH. A single layer of polyelectrolyte was also used as a substrate; in this case, PAH was directly adsorbed on a gold-coated silicon wafer. These reflective samples were used for Grazing angle FTIR studies. Propylaminosilane SAMs were used as substrates for the stability studies. In this case, propylaminosilane SAMs were formed on Si substrates by immersing piranha cleaned Si substrates into a 2 mM ethanol solution of aminopropyltrimethoxy silane (Aldrich) for 2 hours.

Microcontact Printing

The general procedure of polymer-on-polymer stamping is shown in FIG. 7. A 10 mM PS-b-PAA/THF solution (concentration based on the formula weight of the nominal repeat unit of styrene and acrylic acid) was used to ink untreated PDMS stamps molded from lithographically prepared masters. Kumar, A.; Biebuyck, H. A.; Whitesides, G. M. Langmuir 1994, 10, 1498-1511. After evaporation of solvent, the PDMS stamp was briefly dried under a N₂ stream and was brought into contact with the substrate for 10-15 minutes at room temperature. All stamped surfaces were then rinsed with ethanol to remove unbound or loosely bound excess polymer. The substrates used, as described above, include strong polyelectrolyte multilayers capped with PAH at pH 8.5, a single adsorbed monolayer of PAH on silicon, and an amino functionalized SAM on a Si substrate. A PDMS stamp containing an array of 10 μm holes was used, and a water condensation image was immediately taken after the stamping process under optical microscope. Kumar, A.; Biebuyck, H. A.; Whitesides, G. M. Langmuir 1994, 10, 1498-1511.

Characterization

GA-FTIR spectra were obtained in single reflection mode using Digilab Fourier transform infrared spectrometer (Biorad, Cambridge, Mass.). The p-polarized light was incident at 80° relative to the surface normal of the substrate, and a mercury-cadmium-telluride (MCT) detector was used to detect the reflected light. A spectrum of a SAM of n-hexdecanethiolate-d₃₃ on gold was taken as a reference. Laibinis, P. E.; Bain, C. D.; Nuzzo, R. G.; Whitesides, G. M. J. Phys. Chem. 1995, 99, 7663-7676. The buffer solutions used in stability tests were made according to the CRC Handbook of Chemistry and Physics (78^{th} Edition, 1997-1998), but diluted with deionized water to a final ionic strength equal to 10 mM. Accurate pH values were then measured with a pH meter after dilution. Potassium hydrogen phthalate (Aldrich) was used for the preparation of buffer solutions in the range of pH2-5. Potassium dihydrogen phosphate (Aldrich) was used for the preparation of buffer solutions in the range of pH7-10. Contact angles were measured on a Ramé-Hart goniometer (Rame-Hart Inc., Mountain Lakes, N.J.) equipped with a video-imaging system. Water drops were placed on at least three locations on the surface in the ambient environment and measured on both sides of the drops. Contacting water drops were advanced and retreated with an Electrapipette (Matrix Technologies, Lowell, Mass.) at approximately 2 μl/s.

### EXAMPLE 3

Stamping of Polyelectrolytes on Charged Multilayer Surfaces

Substrate Preparation

The strong polyelectrolytes SPS and PDAC were used to form multilayer platforms on which solutions of the same polymers could be stamped. The platforms were built on glass slides cleaned with a dilute Lysol/water mixture in a sonicator. To start the first bilayer, the slides were then immersed for twenty minutes in the PDAC solution (0.02M PDAC, of MW 100,000-200,000, in Milli-Q water, with 0.1M NaCl, filtered to 0.22 microns). Following a two-minute rinse, the slides were placed into the SPS solution (0.01M SPS, of MW 70, 000, in Milli-Q water, with 0.1M NaCl, filtered to 0.22 microns) and allowed to sit for 20 minutes. They were rinsed a second time, and sonicated for three minutes prior to repeating the procedure to make the next bilayer. Clark, S. L.; Montague, M. F.; Hammond, P. T. Macromol. 1997, 30, 7237-7244.

Microcontact Printing of Polyions

The PDMS stamp surfaces had to be made polar to increase their wettability to the polyelectrolyte solutions so that the stamps could be smoothly inked. Thus, clean stamps were placed in air plasma for twenty seconds before inking. The polymer solution, or ink, was then applied to the stamp surface using a cotton swab that was wet with the ink. This thin layer of ink was then dried in air, or with N₂ flow, and the stamp was placed on the multilayer platform and allowed to sit for a specified amount of time. Aqueous solutions of 20 mM PDAC and 0.1 M NaCl in water were used to stamp the polymer from aqueous solution. In this case, the stamping times ranged from 30 to 120 minutes. Ethanol/water mixtures were also used as inks. Five solvents of this type were tried: pure water, 75% water, 50% water, 25% water, and pure ethanol. The PDAC inks made with these solvents had concentrations of 0.025M, 0.1M, or 0.25M (based on repeat unit). In this study, the stamping times were varied systematically from a few seconds to an hour for each ethanol/water combination. Following the stamping process, the patterned surface was rinsed thoroughly with DI water applied directly to the film surface from a solvent squeeze bottle to remove any excess unbound polyelectrolyte.

Characterization

A dye was used to visualize the stamped polyelectrolyte monolayer following the stamping and rinsing processes. The dye used to image the stamped polycation, PDAC, was 6-carboxyfluorescein (6-CF), which was purchased and used as received from Sigma. The dye was dissolved directly in 0.1M NaOH; samples were imaged by dipping the substrates into the dye solution. The dye, which is negatively charged, selectively stained the positively charged PDAC surface. The dyed regions appear green when viewed with the fluorescence optical microscope, using a FITC filter. Caruso, F.; Lichtenfeld, H.; Donath, E.; Mohwald, H. Macromolecules 1999, 32, 2317-2328. Ellipsometry: All ellipsometry measurements were taken with a Gaertner Scientific Corporation ellipsometer, controlled by a Gateway 2000 computer running GEMP software. Fluorescence optical microscopy: All fluorescence optical microscopy was done with a Zeiss Axiovert, using a FITC filter. The pictures taken were captured by a Hamamatsu C4742-95 digital camera, and processed on a Macintosh G3 computer running Open Lab 2.0.2 software. AFM: After stamping polyelectrolytes atop a multilayer platform adsorbed onto SAMs treated Au substrates, the topography of the stamped polyelectrolyte layer was observed using the tapping mode of a Digital Instruments Dimension 3000 atomic force microscope (AFM) with a silicon etched tip (TESP).

### Incorporation by Reference

All of the patents and publications cited herein are hereby incorporated by reference.

### Equivalents

Those skilled in the art will recognize, or be able to ascertain using no more than routine experimentation, many equivalents to the specific embodiments of the invention described herein. Such equivalents are intended to be encompassed by the following claims.

We claim:

1. A method of forming a pattern of a polymer on a surface, comprising the step of applying a polymer to said surface to produce said pattern of said polymer on said surface, wherein said pattern has different properties than said surface.

2. The method of claim 1, wherein the step of applying a polymer to said surface is performed with a stamp.

3. The method of claim 2, wherein the surface is a second polymer.

4. The method of claim 3, wherein the surface is a polymeric multilayer.

5. The method of claim 4, wherein the polymeric multilayer is a polyelectrolyte multilayer.

6. The method of claim 2, wherein said surface comprises a silicon oxide.

7. The method of claim 2, wherein said polymer is covalently bonded to said surface.

8. The method of claim 2, wherein said polymer is attached electrostatically to said surface.

9. The method of claim 2, wherein the polymer is a copolymer.

10. The method of claim 9, wherein the copolymer is a block copolymer.

11. The method of claim 9, wherein the copolymer is a graft copolymer.

12. The method of claim 2, wherein the polymer is a polyelectrolyte.

13. The method of claim 7, wherein the polymer is a copolymer.

14. The method of claim 13, wherein the copolymer is EO-MAL.

15. The method of claim 14, wherein the surface comprises a plurality of amines.

16. The method of claim 8, wherein the polymer is a copolymer.

17. The method of claim 16, wherein the copolymer is a block copolymer.

18. The method of claim 17, wherein the block copolymer is a PS-b-PAA block copolymer.

19. The method of claim 17, wherein the block copolymer is a PS-b-PMA block copolymer.

20. The method of claim 8, wherein the polymer is a polyelectrolyte.

21. The method of claim 20, wherein the polyelectrolyte is PDAC.

22. The method of claim 2, further comprising the step of applying a polyelectrolyte to said surface bearing said pattern.

23. The method of claim 22, wherein the surface comprises a plurality of amines; and the polymer is EO-MAL.

24. The method of claim 2, wherein the stamp is a PDMS stamp.

25. An article having on its surface a pattern formed by the method of claim 1.

26. An article having on its surface a pattern formed by the method of claim 2.

27. The article of claim 26, wherein said article comprises a silicon oxide.
